(19) United States
(12) Patent Application Publication
(10) Pub. No.: US 2015/0042431 A1
(43) Pub. Date: Feb. 12, 2015

(54) COILED ELECTRONIC POWER COMPONENT COMPRISING A HEAT SINKING SUPPORT

(71) Applicant: HISPANO SUIZA, Colombes Cedex (FR)

(72) Inventors: Nicolas Delalandre, Moissy Cramayel (FR); Yannick Collin, Hyeres (FR); Stephane Malet, Moissy Cramayel (FR); Jacques Salat, Brie Comte Robert (FR)

(73) Assignee: HISPANO SUIZA, Colombes Cedex (FR)

(21) Appl. No.: 14/345,497

(22) PCT Filed: Sep. 27, 2012
(86) PCT No.: PCT/FR2012/052191

§ 371 Date: Mar. 18, 2014

(30) Foreign Application Priority Data
Sep. 28, 2011 (FR) 1158671

(51) Int. Cl. H01F 27/22; H01F 27/06

(52) U.S. Cl. CPC H01F 27/22; H01F 27/06
USPC 336/61

(57) ABSTRACT

A coiled electronic power component configured to be mounted on a base, the component including an axially extending magnetic core around which a plurality of turns are wound to form a magnetic coil, and at least one bracket for mounting on the base. The mounting bracket includes at least one drain surface in thermal contact with the magnetic core and/or the plurality of turns to drain calories from the magnetic core and/or from the plurality of turns to the base during operation of the component. The mounting bracket has an equivalent thermal conductivity of greater than 400 W·m⁻¹·K⁻¹.

The present invention relates to the field of thermal control of electronic power components for aeronautic applications.

An aircraft conventionally comprises a large number of electronic power components, in particular for carrying out flight commands or filtering electrical signals. The electronic power components for aeronautic applications are capable of developing power of several tens of kilowatts. Conventionally, electronic power components are used temporarily for durations of several seconds, which generates a low quantity of Joule heat; this heat is absorbed by the mass of the electronic component. The temperature of the electronic power component only increases slightly, and this does not adversely affect its operation.

In order to meet the evolving needs of aircraft manufacturers, it has been proposed that electronic power components be used permanently for durations of several minutes. In practice, after several minutes of use, the temperature of the electronic power component begins to rise until it reaches a limit temperature, above which the operation of the electronic component is no longer optimal.

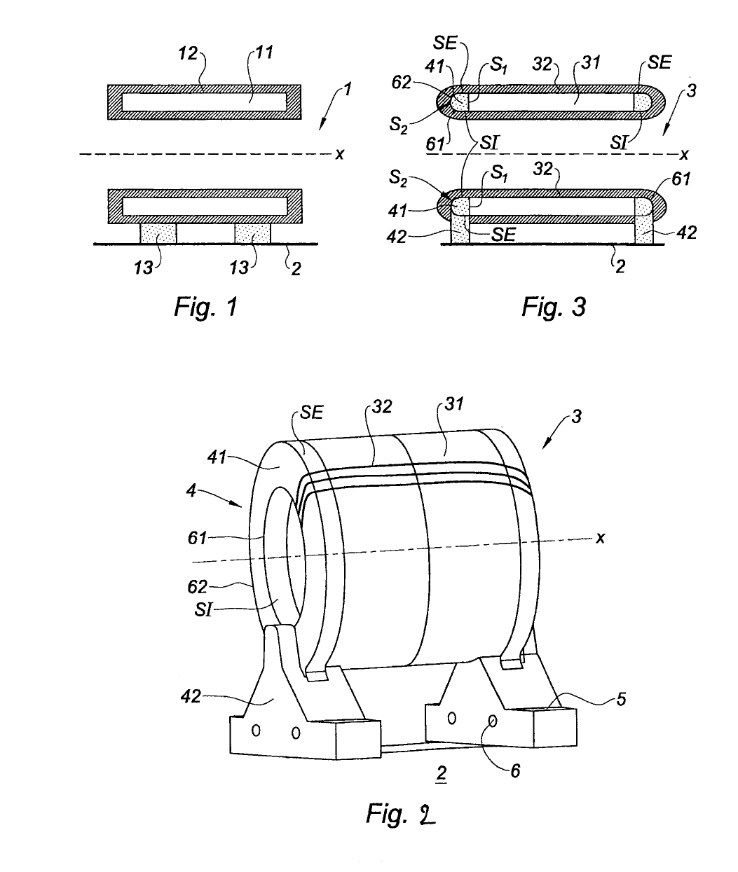

Among the electronic power components, coiled electronic components, which are used in particular for filtering signals, are affected by the rise in temperature. With reference to FIG. 1, a coiled electronic power component 1, referred to in the following as coiled component 1, comprises a toric magnetic core 11, referred to in the following as a toroidal core 11, around which metal turns 12, preferably made of copper, are wound. In practice, above 110° C., the magnetic properties of the toroidal core 11 reduce and the operation of the coiled component 1 is no longer optimal.

The coiled component 1 conventionally comprises mounting tabs 13 which connect turns 12 of the coiled component 1 to a base 2 on which the coiled component 1 is mounted. The temperature of the base 2 is lower than that of the coiled component 1 during operation. In terms of thermal conditions, the base 2 forms a heat sink. In operation, the toroidal core 11 and the turns 12 of the coiled component 1 heat up. As shown in FIG. 1, only the turns 12 are in contact with the mounting tabs 13, which makes it possible to drain the calories from the turns 12 into the base 2. By contrast, the calories generated by the Joule effect in the toroidal core 11 are not satisfactorily drained. Indeed, in order to drain the calories from the toroidal core 11 into the mounting tabs 13, said calories have to travel through the turns 12. The thermal resistance induced by this assembly is very high. The temperature of the coiled component 1 thus remains high, and this prevents it from operating optimally.

To overcome these drawbacks, a first solution consists in increasing the diameter of the coiled component in order to reduce the losses caused by the Joule effect. A solution of this type increases the mass and the dimensions of the coiled component, and is not desirable. A second solution consists in using a rotating fan to produce an air flow for cooling the coiled component. Integrating a rotating fan in an aeronautic application has drawbacks in terms of reliability; therefore, this solution is also ruled out. A third solution would be to use resins, for example of the epoxy type, into which the coiled components would be embedded. In practice, resins of this type do not make it possible to sufficiently limit the heating of a coiled component.

The object of the invention is to produce a coiled electronic power component of which the temperature during operation is regulated while ensuring a mechanical strength that is compatible with an aeronautic application in which the component is subjected to vibrations, accelerations and outside temperatures which vary between −50° C. and +110° C. Another object of the invention is to provide coiled components which are lighter and more compact.

For this purpose, the invention relates to a coiled electronic power component intended to be mounted on a base, the component comprising an axially extending magnetic core around which a plurality of turns are wound to form a magnetic coil, and at least one bracket for mounting on said base, said mounting bracket comprising at least one drain surface in thermal contact with the magnetic core and/or the plurality of turns so as to drain the calories from the magnetic core and/or from the plurality of turns to the base during operation of the component, in which component the mounting bracket has an equivalent thermal conductivity of greater than 400 W·m⁻¹·K⁻¹, preferably of greater than 600 W·m⁻¹·K⁻¹.

The value of the thermal conductivity is defined according to the principal direction in which the mounting bracket conducts the calories from the heat source to the heat sink. Conventionally, the thermal conductivity is determined at ambient temperature, that is, 20° C.

A mounting bracket having high equivalent thermal conductivity makes it possible to effectively drain the calories from the coiled component while making it possible to resist vibrations. If the mounting bracket only consists of one element, the thermal conductivity of the material of the single element corresponds to the equivalent thermal conductivity. If the mounting bracket comprises a plurality of elements (for example a mounting tab and a thermal drain device), the equivalent thermal conductivity corresponds to the thermal conductivity of all of these elements.

Preferably, the mounting bracket is non-magnetic so that it does not heat up by induction.

More preferably, the mounting bracket is made of a composite material. A material of this type has the advantage of being passive and has a high resistance to vibrations. In addition, it is possible to obtain a mounting bracket of any chosen shape, since a composite material can be easily machined.

Preferably, the mounting bracket comprises a composite material loaded with particles having high thermal conductivity which are selected from carbon nanotubes, carbon fibres, diamond particles and graphite particles. Such materials have high thermal conductivities and are compatible with an aeronautic application in which the coiled component is subjected to vibrations, accelerations and outside temperatures which vary between −50° C. and +110° C.

More preferably, the mounting bracket comprises a two-phase thermal drain device so as to increase the equivalent thermal conductivity and thus promote the drainage of calories.

Preferably, the two-phase thermal drain device is a heat pipe.

According to a first aspect of the invention, the two-phase thermal drain device is a pulsating heat pipe.

According to another aspect of the invention, the two-phase thermal drain device is a vapour chamber.

According to a first aspect, since the mounting bracket comprises at least one tab for mounting on the base, the two-phase thermal drain device is mounted on the mounting tab, and this improves the maintenance of the thermal drain device.

According to a second aspect, since the mounting bracket comprises at least one tab for mounting on the base, the two-phase thermal drain device is integrated with the mounting tab, and this makes it possible to increase the equivalent thermal conductivity of the mounting bracket.

Preferably, the mounting bracket comprises a first drain surface in thermal contact with the magnetic core and a second drain surface in thermal contact with the plurality of turns so as to drain the calories from the magnetic core and from the plurality of turns to the base during operation of the component.

The drain surfaces of the mounting bracket make it possible to directly drain the calories from the magnetic core and from the turns, and this improves the thermal regulation of the electronic power component. Advantageously, the presence of the drain surfaces does not increase the mass or the dimensions of the coiled electronic power component. Therefore, the heat generated by the magnetic core does not pass through the turns, but is instead directly drained by the mounting bracket.

Preferably, the first drain surface is substantially equal to the axial section of the magnetic core. A compromise between the thermal drainage capacity (large drain surface) and a limitation of the mass and the dimensions (reduced drain surface) is thus ensured.

Preferably, the turns are wound around the magnetic core and the mounting bracket, which makes it possible for the mounting bracket to be brought into contact with the turns and the magnetic core. In addition, winding the turns advantageously makes it possible to hold the mounting bracket and the magnetic core together.

More preferably, the second drain surface is curved at least in part to reduce the risk of damaging the turns which are wound around the mounting bracket.

According to one aspect of the invention, the mounting bracket comprises an axially extending thermal contact ring, the first and second transverse faces of the ring forming the first drain surface and a part of the second drain surface respectively. One face of the ring is thus in contact with a transverse face of the magnetic core, while the other face of the ring is in contact with the turns.

Preferably, the thermal contact ring has an axial surface which is connected to the second transverse face by a rounded rim. A rounded rim makes it possible to reduce the risk of damaging the turns which are wound around the second transverse face and the axial surfaces of the ring which together form the second drain surface. In addition, a rounded rim, also referred to as a fillet, makes it possible to improve the contact between the turns and the second drain surface.

According to another aspect of the invention, a thermal interface material, preferably thermal grease, is placed between the first drain surface and the magnetic core. A thermal interface material of this type makes it possible to improve the capacity for draining the calories from the magnetic core.

Preferably, the mounting bracket is attached to one end of the magnetic core. Attaching the mounting bracket to one end of the magnetic core makes it possible for the magnetic performance of the core to remain unaffected.

More preferably, the mounting bracket comprises at least one tab for mounting on the base. The mounting tab makes it possible, on one hand, for the calories withdrawn by the drain surfaces to be conducted to the base and, on the other hand, for the vibrations and accelerations associated with the operation of the aircraft to which the component is attached to be resisted.

More preferably, since the component comprises two mounting brackets, said mounting brackets are attached to the ends of the magnetic core. Two brackets being present makes it possible for the coiled component to be effectively secured in an environment which is subjected to vibrations and accelerations, while limiting the mass and dimensions thereof.

The invention will be better understood upon reading the following description, given purely by way of example, and with reference to the accompanying drawings, in which:

FIG. 1 is a cross-section of a coiled electronic power component according to the prior art (and has already been commented upon);

FIG. 2 schematically shows a coiled electronic power component according to the invention in a horizontal position, with only some of the turns being shown;

FIG. 3 is an axial section of the coiled electronic power component in FIG. 2; and

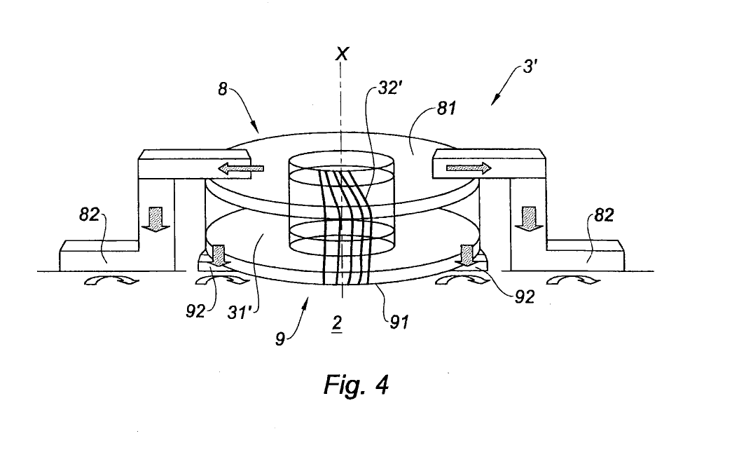

FIG. 4 schematically shows a coiled electronic power component according to the invention in a vertical position, with only some of the turns being shown.

It should be noted that the drawings disclose the invention in a detailed manner for carrying out the invention, it of course being possible for said drawings to be used to better define the invention if necessary.

FIG. 2 shows a first embodiment of a coiled electronic power component 3 according to the invention for an aeronautic application in which the coiled component 3 is subjected to vibrations, accelerations and outside temperatures which vary between −50° C. and +110° C.

The coiled component 3 comprises a toric magnetic core 31, referred to in the following as a toroidal core 31, around which a plurality of turns 32 are wound to form a coil. In this example, the toroidal core 31 is in the form of a longitudinal cylinder having an axis X and having a circular cross-section. The toroidal core 31 is made of a magnetic material such as ferrite. A plurality of turns 32, preferably made of copper, are conventionally wound around the toroidal core 31 to form a magnetic coil as shown in FIG. 2. A coil of this type is capable of generating currents by induction in order to carry out electrical signal filtering operations, for example.

The coiled component 3 is mounted on a structural base 2 which functions as a heat sink, said base preferably being integral with the aircraft. With reference to FIGS. 2 and 3, the base 2 is a horizontal planar plate; however the base 2 can of course be in various forms. With reference to FIGS. 2 and 3, in this first embodiment of the invention the axis X of the toroidal core 31 of the coiled component 3 extends horizontally with respect to the base 2. The coiled component 3 is said to be mounted in a horizontal position on the base 2.

In this example, the coiled component 3 comprises two identical mounting brackets 4 which are mounted at the lateral ends of the toroidal core 31 of the coiled component 3, as shown in FIGS. 2 and 3, in order for it to be possible for said toroidal core to be securely held when it is subjected to vibrations and accelerations.

Each mounting bracket 4 comprises a circular ring 41 which extends axially along the axis X and comprises a first drain surface S1 in thermal contact with the toroidal core 31 and a second drain surface S2 in thermal contact with the plurality of turns 32 so as to drain the calories from the toroidal core 31 and from the plurality of turns 32 to the base 2 in parallel.

Each mounting bracket 4 further comprises a mounting tab 42 which is integral with the circular ring 41 and is capable of being mounted on the base 2. The dimensions of the mounting tab 42 are such that they ensure the mechanical strength of the coiled component 3 in the event of vibrations and accelerations. In this example, the mounting bracket 4 is in the form of a single piece in order to improve the thermal drainage, but the mounting bracket 4 could of course be modular.

Preferably, the mounting bracket 4 is made of a non-magnetic material, preferably of aluminium, so as not to disrupt the induction phenomena between the turns 32 and the toroidal core 31. Advantageously, the self-heating generated by induction is negligible for a non-magnetic material. Aluminium advantageously has a high thermal conductivity as well as a density which is compatible with an aeronautic application.

More generally, the mounting bracket 4 has an equivalent thermal conductivity of greater than 400 W·m⁻¹·K⁻¹ in order to make it possible to effectively regulate the temperature of the coiled component 3 while making it possible to resist mechanical stresses. Preferably, the equivalent thermal conductivity is greater than 600 W·m⁻¹·K⁻¹.

Preferably, the mounting bracket is non-magnetic in order to limit the heating of the bracket by magnetic induction.

According to a first aspect, the mounting bracket is made of a composite material loaded with particles having high thermal conductivity which are selected from diamond particles, carbon nanotubes, carbon fibres and graphite particles. The selection of the particles results from a compromise between the thermal conductivity and the price thereof, this price depending on the thermal conductivity. A composite material of this type is passive and thus has a high resistance to vibrations. In addition, it is possible to obtain a mounting bracket of any chosen shape, since a composite material can be easily machined.

Preferably, a two-phase thermal drain device is mounted on the mounting bracket and makes it possible, owing to the change in phase, for equivalent thermal conductivities of approximately 5000 W·m⁻¹·K⁻¹ to be reached, and this makes it possible for the temperature of the coiled component 3 to be optimally regulated. Preferably, the two-phase thermal drain device is a low-cost heat pipe, the operation of which is controlled, thus ensuring high reliability. Preferably, one side of the heat pipe is connected to the mounting tab 42 and the other side to the base 2.

Preferably, to achieve high thermal conductivity performance, the two-phase thermal drain device is a pulsating heat pipe, which has higher performance and a higher cost, or a vapour chamber, the performance of which is higher than that of a heat pipe for configurations in which the heat sink/heat source surface ratios are high, the cost of a vapour chamber being greater than that of a heat pipe.

In this example, the circular ring 41 has a first transverse surface, forming the first drain surface S1, which is in contact with a lateral surface of the toroidal core 31. The calories accumulated by the toroidal core 31 during operation are thus transmitted directly to the mounting bracket 4 via the first transverse surface of the circular ring 41. To optimise the thermal drainage, the circular ring 41 has an axial section that is substantially equal to that of the toroidal core 31. The section of the circular ring 41 may of course also be less than that of the toroidal core 31. The thickness of the ring 41 is set so as to make effective thermal drainage possible while limiting the mass of the coiled component 3. A good compromise can be ensured with a thickness of the ring 41 of approximately 2 to 3 mm.

The circular ring 41 comprises a second transverse face opposite the first transverse face, the two transverse faces of the ring 41 being connected by an inner axial surface SI and by an outer axial surface SE, as shown in FIG. 2. Still with reference to FIG. 2, the toroidal core 31 and the circular rings 41 of the mounting brackets 4 form an axial cylinder around which the turns 32 are wound, as shown in FIGS. 2 and 3, the turns 32 being in contact both with the axial surfaces of the toroidal core 31 and with the second transverse surface and the axial surfaces SI, SE of the circular rings 41 in order to drain the calories from the turns 32. The second transverse surface and the inner SI and outer SE axial surfaces together form the second thermal drain surface S2 of each mounting bracket 4.

With reference to FIG. 3, the second transverse surface of the ring 41 is connected to the inner axial surface SI by an inner rim 61 and to the outer axial surface SE by an outer rim 62. Preferably, the rims 61, 62 are rounded to reduce the risk of damaging the turns 32 as they are wound around the rings 41. Of course, only one of the rims 61, 62 could be rounded. More generally, the second drain surface S2, which brings the mounting bracket 4 and the turns 32 into contact, is curved to reduce the risk of damaging the turns 32 and to improve the thermal contact between the mounting bracket 4 and the turns 32.

The mounting tab 42 of the mounting bracket 4 preferably comprises means for connecting to the base 2, preferably mounting holes 5 capable of receiving screws for attaching to the base 2, as shown in FIG. 2. In this example, the toroidal core 31 and the rings 41 of the mounting brackets 4 are held together by the winding of the turns 32. Preferably, the mounting brackets 4 comprise holding means (not shown) capable of holding the toroidal core 31 and the two mounting brackets 4 together in order to make it possible for the turns 32 to be wound around the toroidal core 31 and the rings 41 of the mounting brackets 4. Preferably, a longitudinal threaded rod is screwed between the two mounting brackets 4 to regulate the axial distance therebetween, which makes it possible to retain the toroidal core 31 and the winding of the turns 32. With reference to FIG. 2, a mounting tab 42 comprises a longitudinal thread 6 to make it possible for a threaded rod to be screwed therein.

In this example, each mounting bracket 4 comprises one mounting tab 42, but it could of course comprise several. By way of example, the mounting bracket 4 could contain a mounting tab 42 connected to a heat sink other than the base 2. A mounting tab 42 could likewise comprise fins to improve the thermal transfer using the ambient air.

Preferably, a thermal interface material, preferably thermal grease of the Berquist Gap Filler 1500 type, is placed between the first drain surface S1 (in this example, the first transverse face of the ring 41) and the toroidal core 31 to improve the thermal drainage of the toroidal core 31 to the ring 41. Indeed, the toroidal core 31 conventionally has a surface finish that is not satisfactory for making possible homogenous pressure by means of the mounting bracket 4. By adding a thermal interface material, the surface finish of the toroidal core 31 can be improved, and this ensures reliable thermal drainage.

Similarly, a thermal interface material can be applied between the mounting tab 42 and the base 2 to make it possible to transfer calories to the base 2.

During their manufacture, the mounting brackets 4 are mounted on the ends of the toric magnetic core 31, the first transverse face of each ring 41 coming into contact with a transverse face of the end of the toroidal core 31. Preferably, thermal grease is applied to the interface. A copper wire is then wound around the cylindrical assembly formed by the rings 41 and the toroidal core 31 to form turns 32. When it is mounted on an aircraft, the coiled component 3 is attached to the base 2 by screwing its mounting feet 42 via the holes 5. The turns 32 are then connected to other electronic power components to carry out a filtering operation for a power converter, for example. When it is in steady-state operation, calories are generated by the Joule effect in the toroidal core 31 and the turns 32 and are directly drained by the ring 41 of the mounting bracket 4 in order to be transferred into the mounting foot 42 to then be conducted to the base 2 which forms the heat sink, and this makes it possible for the temperature of the coiled component 3 to be regulated during operation.

To ensure good mechanical strength of the assembly, the coiled component 3 can be impregnated with resin.

FIG. 4 shows a second embodiment of a coiled component 3′ according to the invention. Similarly to the first embodiment, the coiled component 3′ comprises a toric magnetic core 31′ around which the turns 32′ are wound. In this second embodiment of the coiled component 3′, the axis X of the toroidal core 31′ extends orthogonally to the base 2, as shown in FIG. 4. The coiled component 3′ is said to be mounted in a vertical position on the base 2.

In contrast to the first embodiment, the coiled component 3′ comprises two mounting brackets 8, 9, which are different. The coiled component 3′ comprises an upper mounting bracket 8 comprising a circular ring 81, which is similar to the ring in the embodiment, and two upper mounting tabs 82 which connect the ring 81 to the base 2 and are diagonally opposite. The coiled component 3′ further comprises a lower mounting bracket 9 comprising a circular ring 91, which is similar to the ring in the first embodiment, and two lower mounting tabs 92 which connect the ring 91 to the base 2.

The upper mounting tabs 82 are, in this example, curved to make it possible to connect the base 2 without disrupting the winding of the turns 32. The lower mounting tabs 92 are, in this example, only supported on the base 2 and do not comprise mounting means, the mounting of the upper mounting tabs 82 ensuring that the coiled component is held on the base 2.

A coiled component 3, 3′ according to the invention can be mounted vertically or horizontally on a base 2, and this is extremely advantageous in terms of dimensions.

1-10. (canceled)

11. A coiled electronic power component configured to be mounted on a base, the component comprising:
an axially extending magnetic core around which a plurality of turns are wound to form a magnetic coil; and
at least one bracket for mounting on the base, the mounting bracket comprising at least one drain surface in thermal contact with the magnetic core and/or the plurality of turns to drain calories from the magnetic core and/or from the plurality of turns to the base during operation of the component,
wherein the mounting bracket has an equivalent thermal conductivity of greater than 400 W·m⁻¹·K⁻¹ at ambient temperature of 20° C., is non-magnetic, and is made of a composite material.

12. A component according to claim 11, wherein the mounting bracket comprises a composite material loaded with particles having high thermal conductivity which are selected from carbon nanotubes, carbon fibers, diamond particles, and graphite particles.

13. A component according to claim 11, wherein the mounting bracket comprises a two-phase thermal drain device.

14. A component according to claim 13, wherein the two-phase thermal drain device is a heat pipe.

15. A component according to claim 14, wherein the two-phase thermal drain device is a pulsating heat pipe.

16. A component according to claim 15, wherein the two-phase thermal drain device is a vapor chamber.

17. A component according to claim 13, wherein the mounting bracket comprises at least one tab for mounting on the base, and the two-phase thermal drain device is mounted on the mounting tab.

18. A component according to claim 13, wherein the mounting bracket comprises at least one tab for mounting on the base, and the two-phase thermal drain device is integrated with the mounting tab.
